(19) United States
(12) Patent Application Publication
(10) Pub. No.: US 2010/0125575 A1
(43) Pub. Date: May 20, 2010

(54) SEARCHING DOCUMENT COLLECTIONS USING SEMANTIC ROLES OF KEYWORDS

(75) Inventor: Hugo Zaragoza, Barcelona (ES)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/272,231

(22) Filed: Nov. 17, 2008

(51) Int. Cl. G06F 7/06; G06F 17/30; G06F 7/00

(52) U.S. Cl. 707/731; 707/E17.014

(57) ABSTRACT

Methods and apparatus are described for facilitating discovery of information of interest in a document collection. A document model is proposed in which important terms and their semantic roles are represented. This document model is then used to facilitate searching and/or browsing of the document collection.

### BACKGROUND OF THE INVENTION

The present invention relates to techniques for searching and/or browsing document collections and, in particular, to techniques which use the semantic roles of search terms.

Browsing a large collection of electronic text (e.g., sentence fragments, sentences, paragraphs, and entire documents) to find relevant information can be extremely difficult; so difficult that in most cases search functionality is used instead of browsing. In search, the user is required to enter keywords which are then used to rank the matching items in the collection. Unfortunately, this approach has its own limitations. For example, search requires the user to know the appropriate keywords in advance. In addition, search suffers from the usual problems of natural language, e.g., synonymy, polysemy, etc. Moreover, search tools provide very little feedback to the user when the search is off the mark.

Browsing, on the other hand, does not require the user to choose keywords. Instead, the user is presented with choices of increasing specificity. For example, in shopping web sites, users naturally browse the collection of products by successively choosing more specific product categories, e.g., electronics→camera→zoom. Each time a user makes a choice, he is presented with a list of results and/or additional choices. This feedback can be very useful because it informs the user about the contents of the collection. It is particularly useful when the user does not have a clear idea of what he is looking for (i.e., a fully specified information need), and is learning as he browses. For instance, in the camera example, the user may realize because of the feedback provided during browsing that there are two types of zooms, i.e., analog and digital.

Unfortunately, there are many cases in which there is no natural taxonomy of the documents in a collection. In such cases, browsing interfaces can be extremely frustrating for the user. And where editor-created taxonomies do exist, they are typically either too general or too specific for the needs of a given user, and/or they may organize information differently from what the user expects. Hierarchical clustering of documents is another alternative to taxonomies that has been used with some success, but has its own drawbacks and often leads to frustrating user experiences.

An alternative to browsing categories or clusters is navigation by keyword selection. An example of this is the use of tag clouds in which the most important tags of a collection are shown to the user. When the user selects a tag, this selection is translated into a restriction (or query) and the collection is restricted to documents containing the selected tag. This approach works well on small, homogeneous collections that are heavily tagged by users. However, it has serious drawbacks in that it cannot be applied to collections which have not been tagged, and degrades rapidly for large or heterogeneous collections.

The shortcoming associated with at least some of the foregoing techniques are further exacerbated where the document collection includes sentence fragments, sentences, and/or short paragraphs in that such documents do not typically have associated metadata, e.g., titles, tags, categories, etc.

### SUMMARY OF THE INVENTION

According to the present invention, methods and apparatus are provided for searching and/or browsing document collections using semantic roles of terms. According to a first class of embodiments, methods and apparatus are provided for searching a collection of documents. A search interface is provided in which a user specifies a search query including a first keyword. One or more suggested keywords are provided in the search interface. The suggested keywords being included in first ones of the documents in which the first keyword is also included. Each of the suggested keywords has a predetermined semantic relationship with the first keyword in one or more of the first documents. Each of the suggested keywords has one or more associated semantic roles explicitly identified in the search interface. A mechanism is provided in the search interface by which the user refines the search query by selecting one of the suggested keywords in a particular semantic role.

According to a second class of embodiments, methods and apparatus are provided for searching a collection of documents. Each of the documents has an associated semantic representation in which each of a subset of the terms in the associated document has a corresponding semantic role. A first keyword is received from a user device. First ones of the semantic representations including the first keyword are identified. One or more suggested keywords having predetermined semantic relationships with the first keyword are identified with reference to the first semantic representations. The suggested keywords are transmitted to the user device.

A further understanding of the nature and advantages of the present invention may be realized by reference to the remaining portions of the specification and the drawings.

### BRIEF DESCRIPTION OF THE DRAWINGS

FIG. 1 is a flowchart illustrating a particular embodiment of the invention.

FIGS. 2-11 are simplified representations of an interface with which a document collection may be search and/or browsed according to a specific embodiment of the invention.

FIG. 12 is a simplified diagram of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the present invention enable a user to develop and refine a search query by constraining the semantic role of specific keywords. According to a particular class of embodiments, a search/browsing interface is provided which suggests additional keywords corresponding to documents in the collection being searched which also include the particular keyword in the semantic role to which it is being constrained. In this way, the user can readily identify and incorporate additional search terms into his query which relate to the topic of interest; even where he was not initially sure what he was looking for. The suggested keywords are identified using an underlying document model in which documents are represented with reference to important terms and their corresponding semantic roles.

As used herein, the term “document” refers to any electronically stored and searchable body of text including, for example, phrases, sentence fragments, sentences, collections of sentences, paragraphs, collections of paragraphs, abstracts, summaries, titles, metadata descriptions, entire documents, etc. Such bodies of text may be embodied in a variety of forms including, for example, plain text, web pages, word processing documents, pdf files, metadata associated with other documents or media, etc.

A particular embodiment of the invention will now be described in which the collection of documents being searched and/or browsed is the Yahoo! Answers collection. It should be noted, however, that this collection is being used herein for illustrative purposes only, and that the invention is not so limited. That is, embodiments of the present invention may be used to discover information in any of a wide variety of document collections that include documents having a wide variety of characteristics.

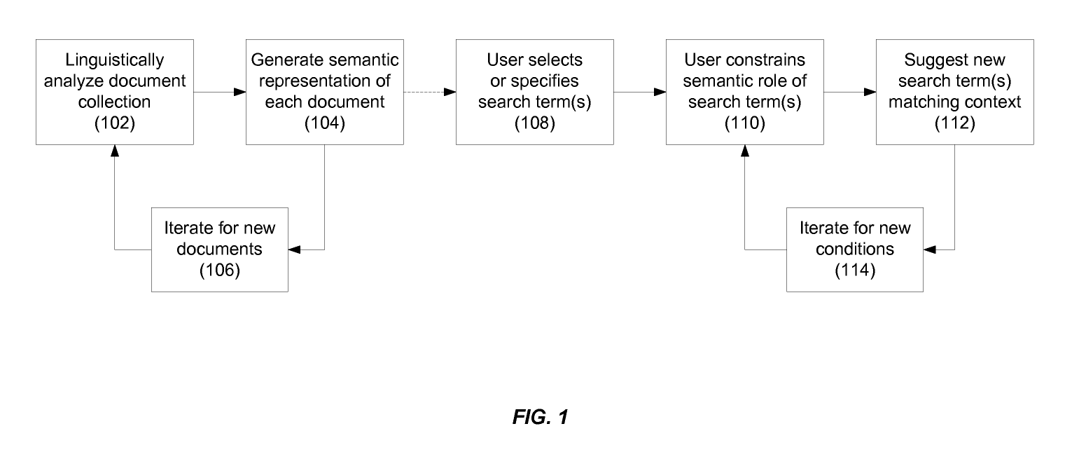

The Yahoo! Answers collection includes user-generated questions which are associated with corresponding answers also generated by Yahoo! users. A user of Yahoo! Answers may pose virtually any question relating to virtually any topic and have that question answered by one or more other Yahoo! users relatively quickly. The user may also search the collection or browse a hierarchy of categories in a conventional manner to determine whether someone has already posed the question, and whether any satisfactory answers were provided. However, given the large number of questions and answers in the collection, these conventional approaches may suffer from the limitations described above. Therefore, an embodiment of the present invention by which a user may more readily identify relevant information in such a collection will now be described with reference to the flowchart of FIG. 1.

Each of the sentences in the collection is linguistically analyzed and tagged to identify the most important elements of the sentence (102). Semantically, the most important elements of a sentence are an “action” to which the sentence refers, and the “patient” and “agent” of the action. Therefore, according to a specific embodiment of the invention, each sentence in the collection is represented by at least one triplet comprising these elements, i.e., <agent, action, patient> also referred to herein as a “frame” (104). This document model may be understood with reference to the sentence “Last week, Corporation A sued Corporation B for patent infringement.” This sentence would be parsed and then represented with the triplet <Corporation A, to sue, Corporation B>.

Other sentence components having various semantic roles may also be identified for particular sentences. Such components and semantic roles may include, for example, temporal qualifiers, spatial qualifiers, geographic modifiers, and modality qualifiers. Modern statistical parsers are able to detect these elements automatically in a sentence with reasonably high accuracy. An example of a statistical parser which may be employed with various embodiments of the invention is described in Combination Strategies for Semantic Role Labeling, Mihai Surdeanu, Lluis Marquez, Xavier Carreras, and Pere R. Comas, Journal of Artificial Intelligence Research 29 (2007), the entire disclosure of which is incorporated herein by reference for all purposes. And as documents are added to the collection, they may be analyzed, tagged, and represented in the same way (106). As will be understood, and as represented by the dashed line, the linguistic analysis of the document collection typically occurs at a different time (e.g., offline), and typically independently of the use of the resulting document model in facilitating information discovery as described below.

By determining the actions, patients, and agents of each of the documents in the collection, the techniques enabled by the present invention are then able to leverage this document model to suggest interesting search terms to the user which help the user to better understand the contents of the collection as well as strategies for suitably specifying and/or refining his query. As will be described, users select or specify not only search terms (108), but may also constrain the semantic roles of one or more of their search terms (110). New terms are then suggested to the user that “match” the semantic context in some way (112). For example if a user chooses an action such as “wash,” new terms such as “dishes” and “cars” may be presented as possible patients of the action. Alternatively, if the user chooses the patient “car,” actions such as “buying,” “washing,” “repairing,” etc., may be suggested. This feedback helps the user understand what types of documents can be found in the collection and to refine his query as needed. As will be described in greater detail below, the user's interactions iteratively constrain the semantic context to zero in on the information of interest (114).

As will be understood, if a document is larger than a single sentence, e.g., a compound sentence, a collection of sentences, a paragraph, a lengthy documents, etc., there may be multiple frames associated with the document, i.e., one for each triplet identified. In some cases, there may be multiple frames for a single sentence. For example, the sentence “I kick the ball and you stop it” includes two frames, <I, kick, ball> and <you, stop, ball>. According to some embodiments, the number of frames for a given document can be reduced by determining which frames are more relevant to the content focus of the document.

According to a particular implementation, once a collection is analyzed and tagged, the collection and the underlying document model may be conceptualized as three relational tables T, S, and R in which the rows of the tables are given by:

T: (documentId, document_text)—i.e., the text of a particular document (e.g., sentence).

S: (frameId, documentId)—i.e., the document in which a frame appears.

R: (term, frameId, role)—i.e., the frame and semantic role of a particular term.

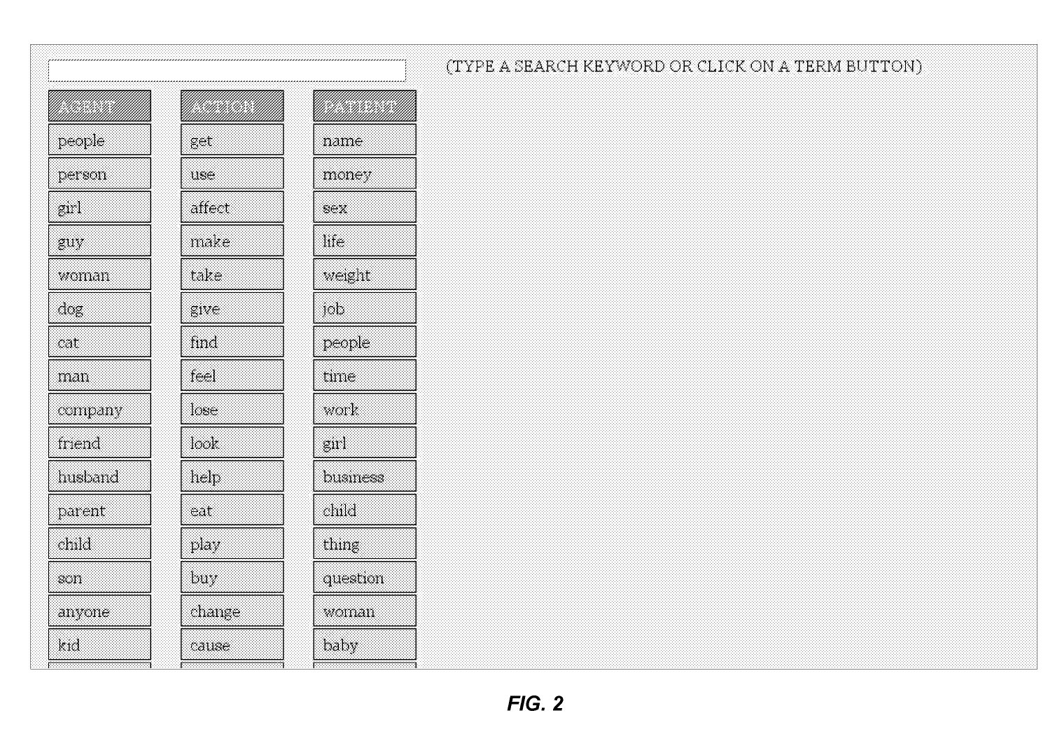

Various modes of interaction with search interfaces implemented according to the invention are contemplated. Two interrelated modes are described below with reference to the examples illustrated in screen shots of FIGS. 2-11. In the depicted embodiments, the user is presented with multiple columns of ranked terms appearing in the document collection, each column representing one of at least three semantic roles, i.e., agent, action, patient, as well as a few others. The user's interactions with the interface generate frame conditions that facilitate the searching and/or browsing of a document collection such as, for example, the Yahoo! Answers collection. Use of these frame conditions, in addition to term filtering and term relatedness, is described below.

A frame condition is a set of constraints on query terms and their roles that can be used to select a subset of the collection, e.g., sentences containing roles that satisfy the constraints, as well as to filter and/or reorder the terms presented in the columns of terms. For example, a frame condition specifying documents in which the term “wash” is an action and the term “shirt” is a patient may be expressed (Action=wash, Patient=shirt). The expression R[Action=wash] denotes the rows in R that contain both the term “wash” and the semantic role “action,” i.e., identifies any frameId for which this is true. User search and browsing actions (e.g., entering or clicking on a word) are translated into frame conditions which are then used to select corresponding documents and/or suggest additional search terms in accordance with specific embodiments of the invention.

FIG. 2 shows a search interface which includes a text box in which the user may enter search terms and provides three browsing columns of terms which appear in the document collection (e.g., Yahoo! Answers) in the semantic roles indicated. The terms in the columns may be ranked as follows. A term ranking function takes a frame selection R[frame condition], and a (Role,term) couple, and returns a term score for the couple. Two types of term ranking functions are described herein, although other ranking functions may be employed without departing from the invention.

Term filtering ranking functions measure the interest of a term being used as a new frame condition. For example, for R[Verb=wash] the term interest for (Patient,car) may be 0.1, and for (Patient, sock) 1.0, indicating that sock is likely a more interesting choice for the user than car. An example of a term interest function is the number of frames in which (Role,term) appears in R[frame condition].

Term relatedness ranking functions measure how semantically related two terms are. According to one approach, semantically related terms may be identified by identifying different terms in a particular semantic role which have the same terms in one or both of the other semantic roles in a triplet, e.g., another action with the same agent and patient. For example, for R[Verb=wash] the term relatedness for (Verb,clean) may be 1.0, and for (Verb,buy) may be 0.1, indicating that clean is likely more related to wash than to buy. An example of a term relatedness function for two verbs is the number of patient roles that are shared in R[frame condition].

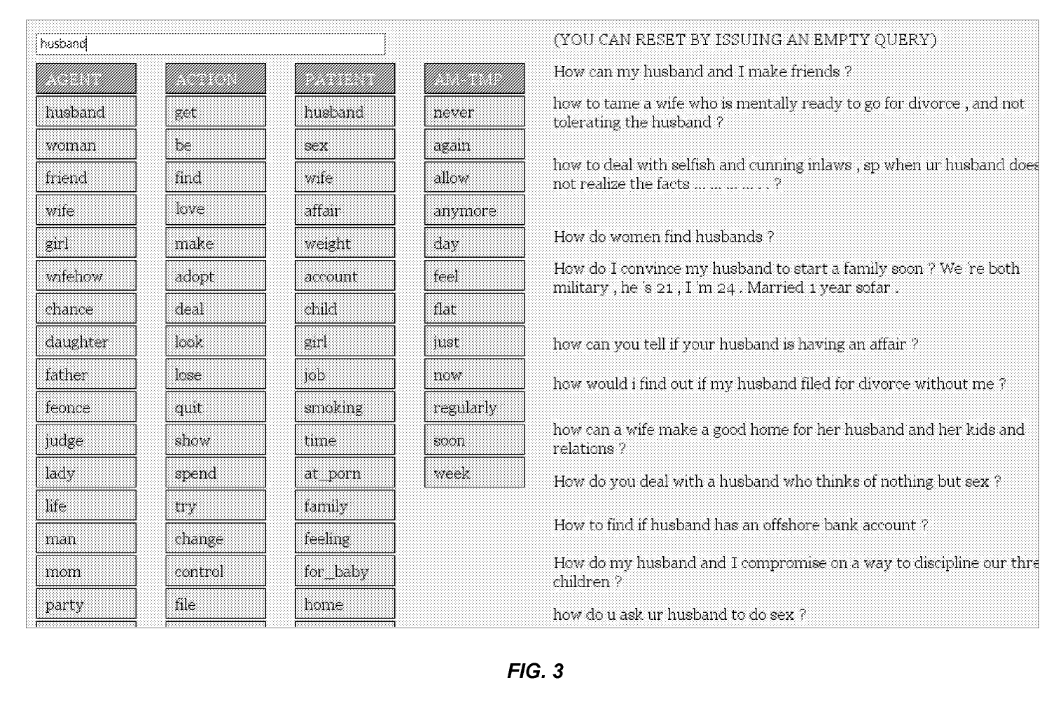

As shown in the examples of FIG. 3 et seq., next to the browsing columns the user is shown some portion of the documents (in this case sentences) which satisfy the current frame condition(s). Each time the user clicks on a term in a browsing column, the click is translated into a frame condition and is ANDed to the previous condition(s). That is, R[frame condition] is updated, the relevant measures recomputed, and the browsing columns as well as the sentences shown are updated. Deselecting a term (e.g., by clicking on a browsing column term that was previously selected) results in removing the corresponding condition and another corresponding updating of R. As will be understood, a variety of mechanisms may be provided to support adding, removing, and modifying conditions, as well as navigating back and forth through a succession of conditions. Such mechanisms might include, for example, a reset button or control, back and forward buttons or controls, etc.

When a user selects a term in one of the browsing columns, e.g., “people” in the agent column of FIG. 2, if an agent browsing column is still to be shown, it makes more sense for the terms in the new agent column to be sorted using term relatedness rather than term filtering. That is, the user has indicated by her action that the intended agent is “people.” Therefore, it makes sense to provide alternative synonymous suggestions for agent rather than, for example, a list filtered by frequency. In such a case, selecting a term in a particular column results in a frame condition which replaces or represents a logical OR with the previous frame condition on that column.

It should be noted that the browsing columns and the order of the terms in each can be predetermined, or generated on the fly as the user makes selections. Columns can also be merged. For example, the browsing columns for Patient and Agent could be merged given that there are sentence structures which include only one entity associated with an action.

According to some implementations, traditional search functionalities can be integrated with user interfaces implemented according to the invention. That is, as discussed above, when a user types keywords in the search text box, the keywords may be translated into frame conditions, e.g., with the keyword being the term and the role being empty (i.e., it is not yet clear what semantic role the user intends). For example, if the user enter “dog” in the search box, this may be represented as the frame condition (ANY_ROLE, dog) and logically ANDed with any other conditions. In this way R[frame condition] can be updated naturally in response to this mode of interaction with the interface.

According to specific embodiments, various types of modifiers (e.g., temporal, modality, spatial, geographic, etc.) may be surfaced if they have some statistical significance to the current context. For example, many sentences might share a common action but have very different temporal modifiers, e.g., today, this week, next week, next year, last month, etc. In such cases it may be useful to provide these options to the user for refining of her query.

The concept of tags (e.g., people, places, etc.) may also be employed with particular implementations to leverage the underlying document model. For example, entering the keyword “Pablo Picasso” will identify all documents in the collection in which this keyword appears as either an agent or a patient. The user may then be given the option of selecting a tag or category, e.g., people or places associated with Pablo Picasso. Because each of the documents has been parsed to derive representative triplets, and if each of the terms in the triplet also has associated tags, it is possible then to identify from the triplets all people or places that are identified with Pablo Picasso in the document collection.

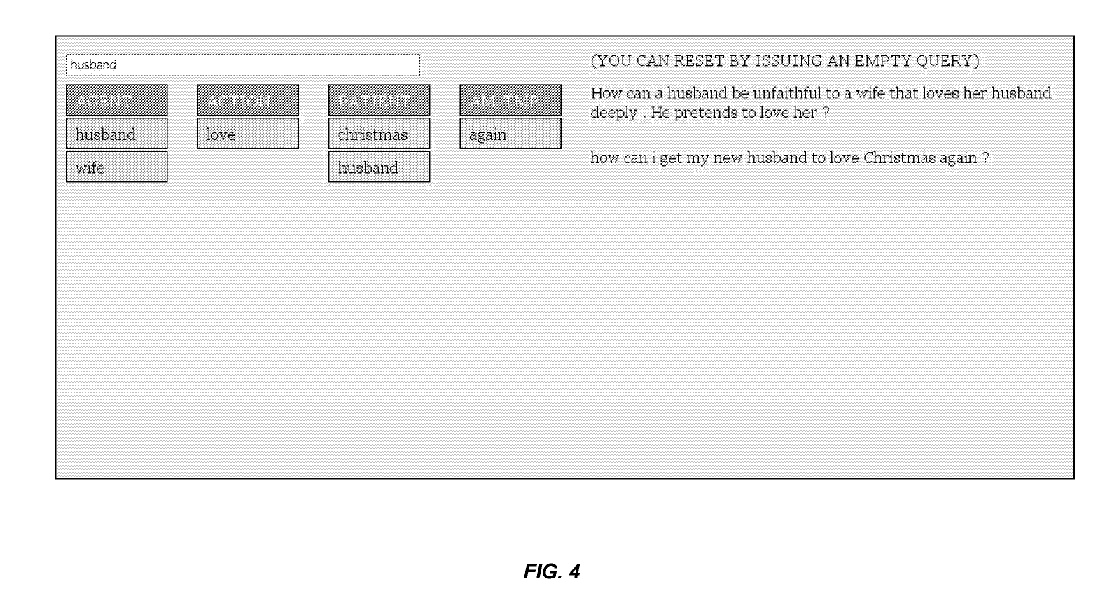

Some examples of the foregoing functionalities may be illustrative. If the user enters the search term “husband” in the search text box as shown in FIG. 3, the frame condition (ANY_ROLE, husband) results in the reordering of the semantic role columns relative to FIG. 2 as shown. An additional browsing column (Action Modifier—TeMPoral) is surfaced which includes temporal modifiers having statistical relevance in the subset of documents containing the keyword “husband.” Documents (i.e., questions) are shown which correspond to the current frame condition, i.e., include the term “husband” in any semantic role. If the user then selects the action “love,” the additional frame condition constrains both the set of documents and the terms in the browsing columns as shown in FIG. 4.

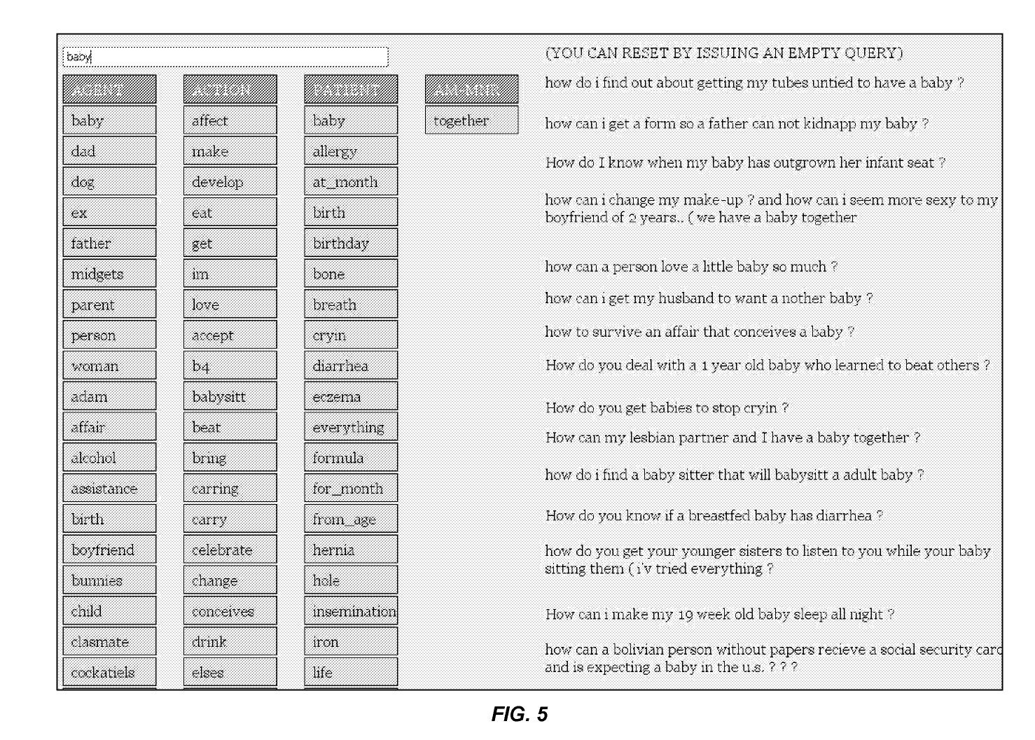

In another example shown in FIG. 5, when the user enters the term “baby” in the search text box, the terms in the browsing columns are filtered and reordered as shown. As with the “husband” example of FIG. 3, the term “baby” is shown in the top position in both the agent and patient browsing columns as the user has not yet specified the semantic role. An additional browsing column (Action Modifier—MaNneR) is also surfaced with a single term “together” that has some statistical significance in the document set corresponding to the current context. Representations of documents in which the term “baby” appears in any semantic role are also provided.

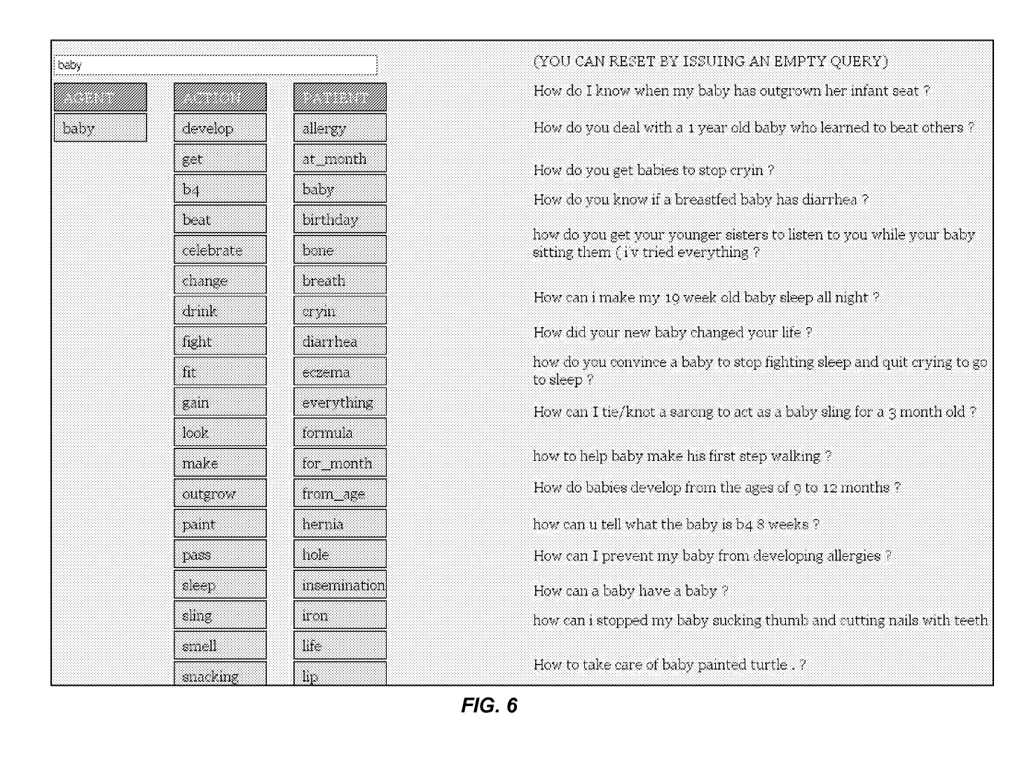

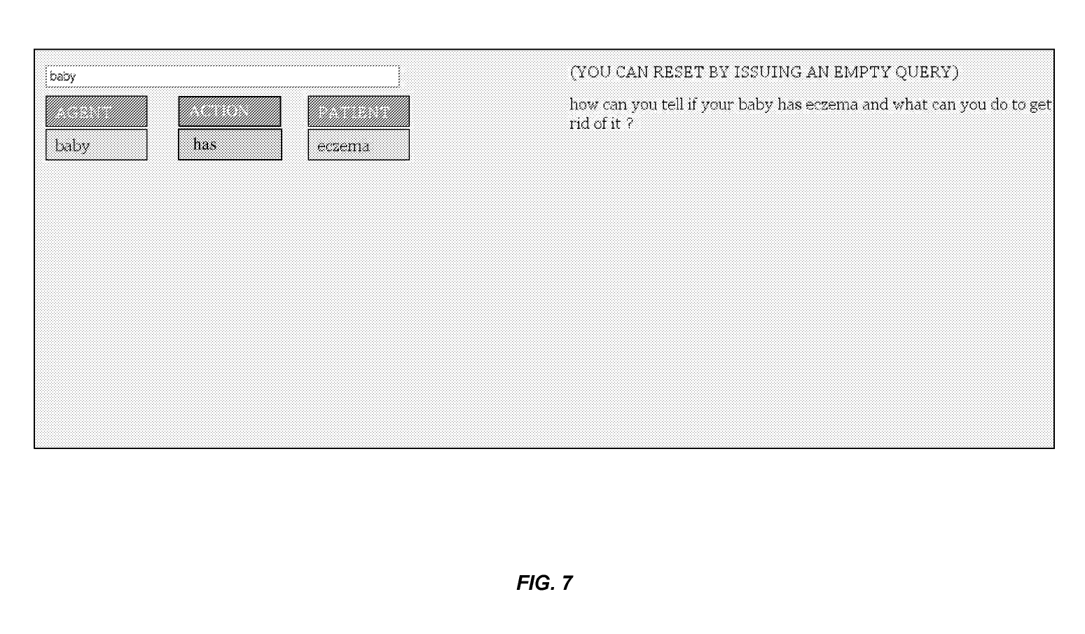

By contrast, when the user selects “baby” to be an agent as shown in FIG. 6, the agent column is reduced to only include the term “baby,” while the action and patient columns, as well as the document representations, are filtered and reordered to correspond to the new frame condition(s). In this example, the fourth column disappears as the modifier in the previous view no longer is relevant to the current context. Finally, by selecting the term “eczema” in the patient column, the additional frame condition constrains both the set of documents and the terms in the browsing columns as shown in FIG. 7.

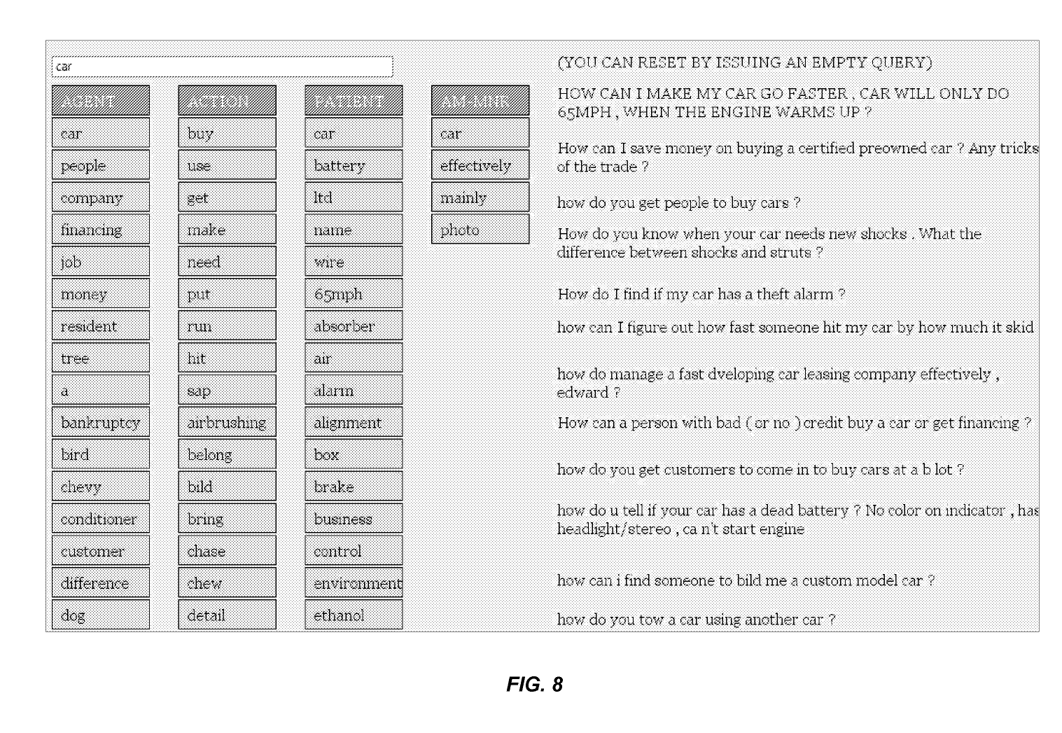

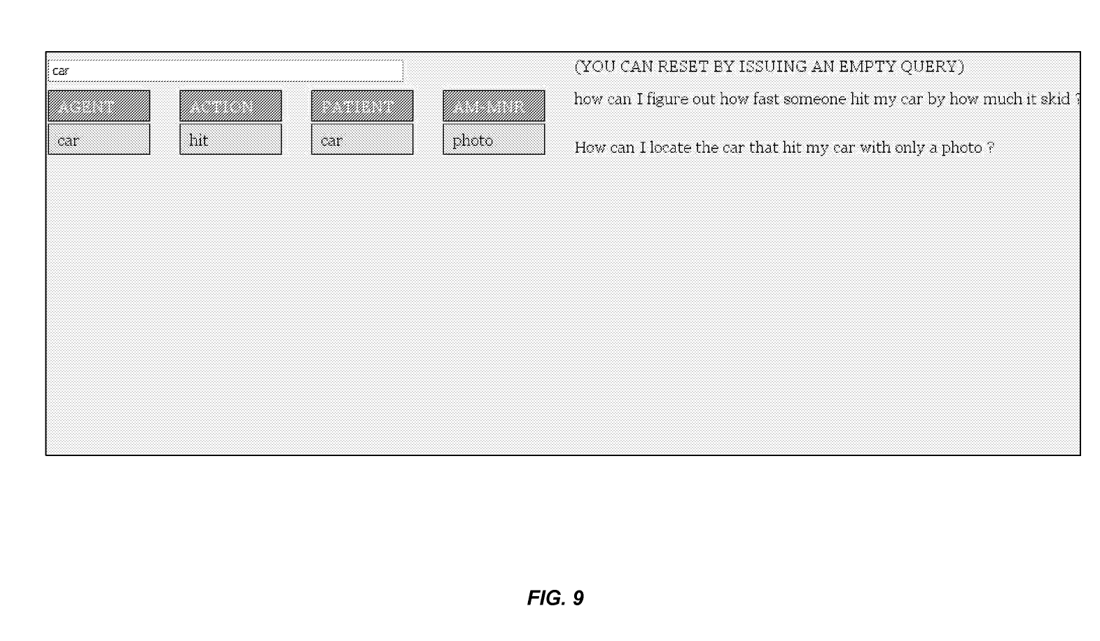

In the example illustrated in FIG. 8, the user enters the term “car” in response to which the terms in the browsing columns are filtered and reordered as shown. Again, an additional browsing column is surfaced, this time with several terms that have statistical significance in the document set corresponding to the current context. If the user then selects the action “hit,” the additional frame condition constrains both the set of documents and the terms in the browsing columns as shown in FIG. 9.

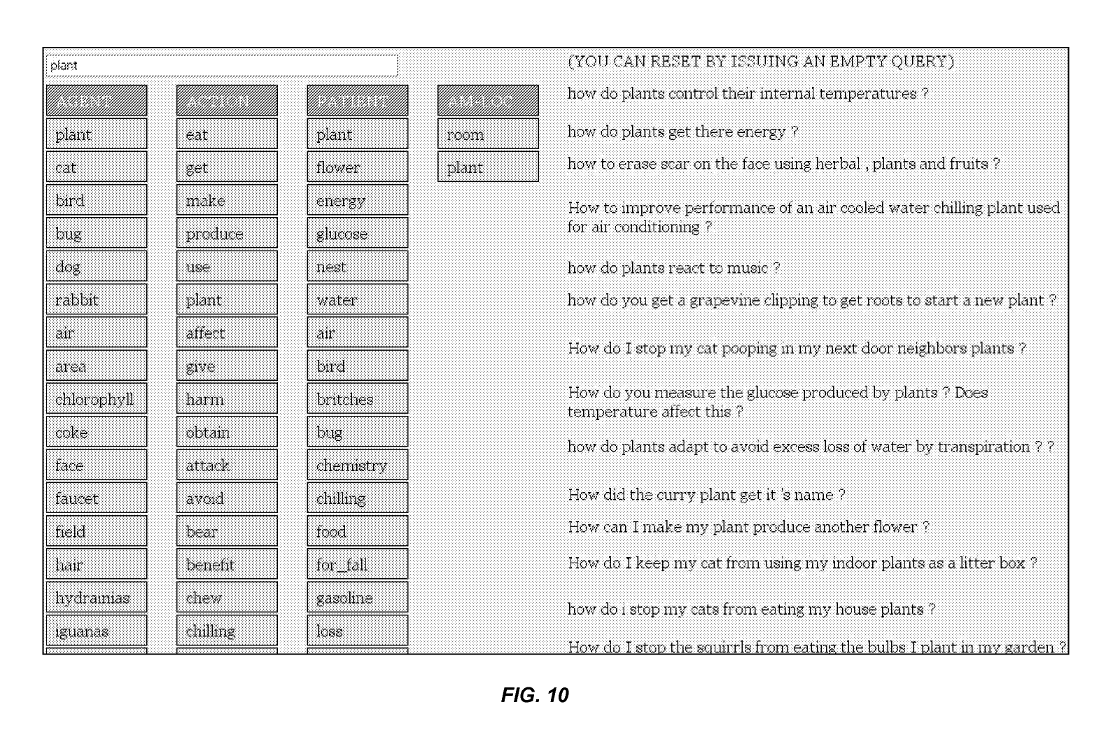

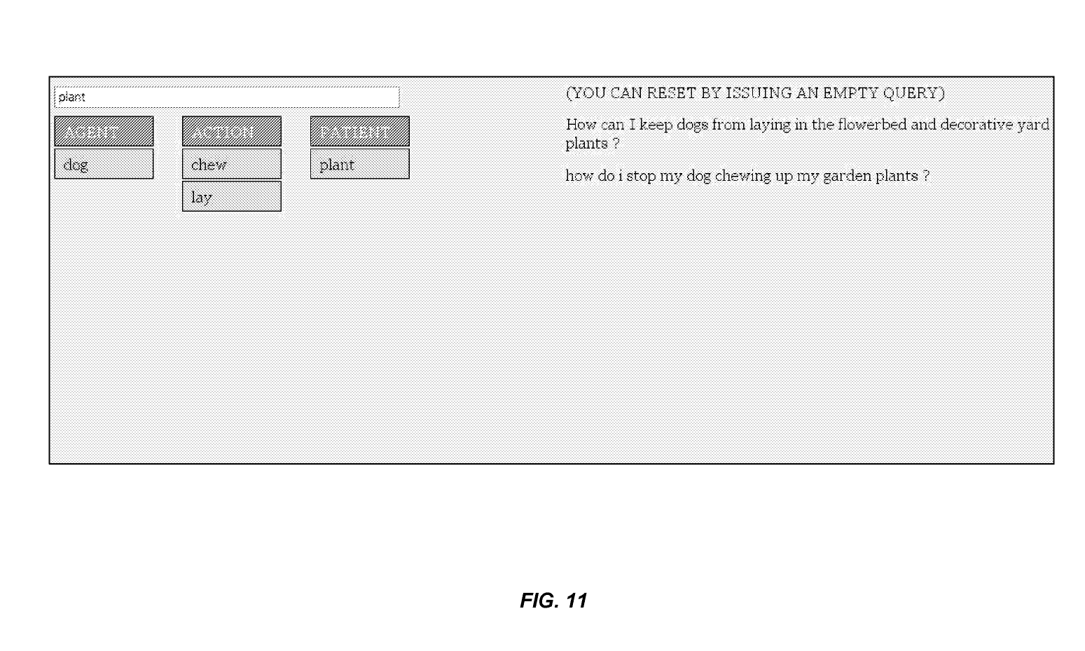

In the example illustrated in FIG. 10, the user enters the keyword “plant” in the search text box, in response to which the terms in the browsing columns and the documents presented are filtered and ordered as shown. Note that the term “plant” appears in each of the semantic role columns, including as a location or spatial modifier (Action Modifier—LOCation). Specification by the user that the term has the semantic role “patient,” i.e., by selecting “plant” in the patient column results in the filtering and reordering of terms and documents as shown in FIG. 11.

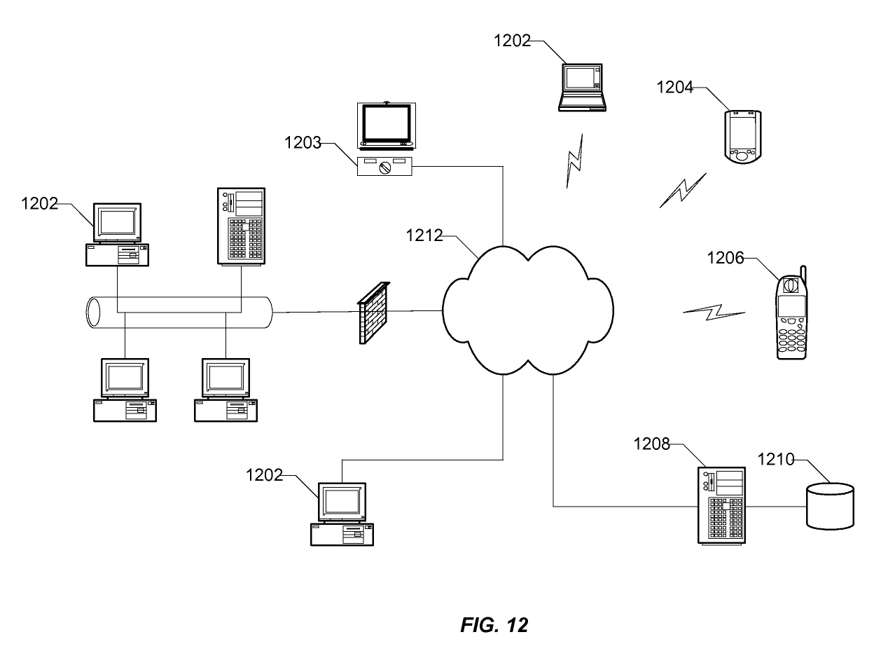

Embodiments of the present invention may be employed to provide search and browsing services for document collections in any of a wide variety of computing contexts and using any of a wide variety of technologies. For example, as illustrated in FIG. 12, implementations are contemplated in which the relevant population of users interacts with a diverse network environment via any type of computer (e.g., desktop, laptop, tablet, etc.) 1202, media computing platforms 1203 (e.g., cable and satellite set top boxes and digital video recorders), handheld computing devices (e.g., PDAs) 1204, cell phones 1206, or any other type of computing or communication platform. The parsing of document collections and the providing of search and browsing services for such document collections are represented in FIG. 12 by server 1208 and data store 1210 which, as will be understood, may correspond to multiple distributed devices and data stores operated by one or more entities.

The invention may also be practiced in a wide variety of network environments (represented by network 1212) including, for example, TCP/IP-based networks, telecommunications networks, wireless networks, etc. In addition, the computer program instructions with which embodiments of the invention are implemented may be stored in any type of tangible computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for searching a collection of documents, comprising:
providing a search interface in which a user specifies a search query including a first keyword;
providing one or more suggested keywords in the search interface, the suggested keywords being included in first ones of the documents in which the first keyword is also included, each of the suggested keywords having a predetermined semantic relationship with the first keyword in one or more of the first documents, each of the suggested keywords having one or more associated semantic roles explicitly identified in the search interface; and
providing a mechanism in the search interface by which the user refines the search query by selecting one of the suggested keywords in a particular semantic role.

2. The method of claim 1 further comprising presenting representations of a subset of the first documents that include the selected suggested keyword in the particular semantic role.

3. The method of claim 1 wherein the particular semantic role comprises one of agent, action, patient, temporal qualifier, spatial qualifier, geographic modifier, or modality qualifier.

4. The method of claim 1 wherein the suggested keywords are ordered in the search interface with reference to a frequency with which each of the suggested keywords appears in the collection of documents in the one or more associated semantic roles.

5. The method of claim 1 wherein the suggested keywords are ordered in the search interface with reference to a measure of semantic relatedness between the first keyword and each of the suggested keywords.

6. The method of claim 1 further comprising presenting representations of at least some of the first documents in the search interface.

7. A computer-implemented method for searching a collection of documents, each of the documents having an associated semantic representation in which each of a subset of the terms in the associated document has a corresponding semantic role, the method comprising:
receiving a first keyword from a user device;
identifying first ones of the semantic representations including the first keyword;
identifying one or more suggested keywords having predetermined semantic relationships with the first keyword with reference to the first semantic representations; and
transmitting the suggested keywords to the user device.

8. The method of claim 7 further comprising receiving a selected one of the suggested keywords from the user device, and identifying a subset of the first semantic representations that include the selected suggested keyword in a semantic role.

9. The method of claim 8 further comprising transmitting representations of a subset of the documents corresponding to the subset of the first semantic representations to the user device.

10. The method of claim 8 wherein the semantic role comprises one of agent, action, patient, temporal qualifier, spatial qualifier, geographic modifier, or modality qualifier.

11. The method of claim 7 further comprising ordering the suggested keywords with reference to a frequency with which each of the suggested keywords appears in the semantic representations of the documents in a particular semantic role.

12. The method of claim 7 further comprising ordering the suggested keywords with reference to a measure of semantic relatedness between the first keyword and each of the suggested keywords.

13. The method of claim 7 further comprising transmitting representations of a subset of the documents corresponding to the first semantic representations to the user device.

14. A system for searching a collection of documents, comprising:
system memory having a semantic representation of each of the documents stored therein in which each of a subset of the terms in the corresponding document has a corresponding semantic role; and
one or more computing devices configured to:
receive a first keyword from a user device;
identify first ones of the semantic representations including the first keyword;
identify one or more suggested keywords having predetermined semantic relationships with the first keyword with reference to the first semantic representations; and
transmit the suggested keywords to the user device.

15. The system of claim 14 wherein the one or more computing devices is further configured to receive a selected one of the suggested keywords from the user device, and identify a subset of the first semantic representations that include the selected suggested keyword in a semantic role.

16. The system of claim 15 wherein the one or more computing devices is further configured to transmit representations of a subset of the documents corresponding to the subset of the first semantic representations to the user device.

17. The system of claim 14 wherein the one or more computing devices is further configured to order the suggested keywords with reference to a frequency with which each of the suggested keywords appears in the semantic representations of the documents in a particular semantic role.

18. The system of claim 14 wherein the one or more computing devices is further configured to order the suggested keywords with reference to a measure of semantic relatedness between the first keyword and each of the suggested keywords.

19. The system of claim 14 wherein the one or more computing devices is further configured to transmit representations of a subset of the documents corresponding to the first semantic representations to the user device.
